(19) United States
(12) Patent Application Publication
(10) Pub. No.: US 2017/0097881 A1
(43) Pub. Date: Apr. 6, 2017

(54) SYSTEM AND METHOD FOR PERFORMING DATA ANALYTICS FOR A MACHINE ON A MOBILE DEVICE

(71) Applicant: Caterpillar Inc., Peoria, IL (US)

(72) Inventors: Benjamin J. Hodel, Dunlap, IL (US); Aaron R. Shatters, Montgomery, IL (US); Eric W. Cler, Oswego, IL (US); Vishnu Suganth Prabhakaran, Chennai (IN)

(73) Assignee: Caterpillar, Peoria, IL (US)

(21) Appl. No.: 15/237,698

(22) Filed: Aug. 16, 2016

Related U.S. Application Data
(60) Provisional application No. 62/236,750, filed on Oct. 2, 2015.

(51) Int. Cl. G06F 11/36; G06F 9/445

(52) U.S. Cl. CPC G06F 11/3672; G06F 8/65

(57) ABSTRACT

A method for operating a machine using a mobile device is provided. The method includes connecting wirelessly, by a mobile device processor, a mobile device to an electronic controller unit of a machine; receiving, at the mobile device processor, machine data for machine parameters associated with the machine from the electronic controller unit, the machine data being in a machine data structure; applying, at the mobile device processor, a constraint to the machine data in response to a query received at the mobile device processor; generating, at the mobile device processor, result data in a mobile device data structure based upon the constraint applied to the machine data; and modifying, by the mobile device processor, an operation of the machine based upon the result data.

### CROSS-REFERENCE TO RELATED APPLICATIONS

This application claims the benefit of U.S. Provisional Patent Application No. 62/236,750, entitled “SYSTEM AND METHOD FOR PERFORMING DATA ANALYTICS FOR A MACHINE ON A MOBILE DEVICE,” filed on Oct. 2, 2015.

### TECHNICAL FIELD

This patent disclosure relates generally to e data analytics for machines, and more particularly, to a system and a method for performing data analytics for a machine on a mobile device.

### BACKGROUND

Conventional systems and methods for machines include on-board processing of machine data by an electronic controller module (ECM) or electronic controller unit (ECU) inside or on-board the machine. The ECM/ECU processes large amounts of machine data in a raw or native machine data structure that take up a large amount of communication bandwidth when transmitted to off-board devices remote from the machine. The machine data structure may have a raw unprocessed format. Some conventional systems monitor parameters associated with the machine and may provide selective vehicle information to a terminal on the machine. Such a terminal is on-board and may then transmit vehicle data to a provider center or third party through a mobile computing platform on the vehicle itself over a mobile communications system infrastructure.

Further, data analytics of machine-level information are increasingly moving on-board due to faster response-times, wider production sample sizes, and cost-avoidance through data reduction opportunities. However, the conventional method for developing these algorithms is slow (greater than 12 month validation cycles), costly, and impossible to iterate quickly. In addition, the availability of integrated hardware for developing or running such algorithms may not be in production for several years, and even then, only on new models of machine equipment.

Some conventional systems, such as the one disclosed in U.S. Patent Application Publication No. 2015/0004572 (the '572 publication) by the same applicant as this patent application, use a portable apparatus for processing machine data. The portable apparatus is not integral to the machine. However, the '572 publication is directed towards a specific application of real-time operation-based operator coaching system based upon the machine data processed at the portable device.

There is a continued need for a mobile computing platform that can be flexibly programmed in real-time as the machine is operated to process machine data for specific applications as requested by a user or customer using the machine in a format understandable by the user or the customer of the machine. The present disclosure addresses these problems and other problems associated with the conventional systems and methods.

### SUMMARY

Various aspects of this disclosure are related to managing information flow and analytical processing for gaining machine operational insights using data analytics carried out on a mobile device, for example, a mobile phone.

In one aspect of this disclosure, a method for operating a machine using a mobile device is provided. The method includes connecting wirelessly, by a mobile device processor, a mobile device to an electronic controller unit of a machine; receiving, at the mobile device processor, machine data for machine parameters associated with the machine from the electronic controller unit, the machine data being in a machine data structure; applying, at the mobile device processor, a constraint to the machine data in response to a query received at the mobile device processor; generating, at the mobile device processor, result data in a mobile device data structure based upon the constraint applied to the machine data; and modifying, by the mobile device processor, an operation of the machine based upon the result data.

In another aspect of this disclosure, a system is provided. The system includes a machine including an electronic controller unit; and a mobile device wirelessly connected to the electronic controller unit. The mobile device includes a mobile device processor configured to communicate wirelessly with the electronic controller unit to receive machine data for machine parameters associated with the machine from the electronic controller unit, the machine data being in a machine data structure, apply a constraint to the machine data in response to a query received at the mobile device processor, generate result data in a mobile device format based upon the constraint applied to the machine data; and modify an operation of the machine based upon the result data.

In yet another aspect of this disclosure, a non-transitory computer readable medium comprising computer executable instructions for operating a machine using a mobile device wirelessly connected to an electronic controller unit of the machine is provided. The computer executable instructions when executed by a mobile device processor cause the mobile device processor to communicate wirelessly with the electronic controller unit to receive machine data for machine parameters associated with the machine from the electronic controller unit, the machine data being in a machine data structure, apply a constraint to the machine data in response to a query received at the mobile device processor, generate result data in a mobile device format based upon the constraint applied to the machine data, and modify an operation of the machine based upon the result data.

### BRIEF DESCRIPTION OF THE DRAWINGS

FIG. 1 illustrates a system for operating a machine based on machine data analytics performed on a mobile device, in accordance with an aspect of this disclosure.

FIG. 2 illustrates a flowchart for a method for operating a machine based on machine data analytics performed on a mobile device, in accordance with an aspect of this disclosure.

FIG. 3 illustrates a flowchart for an operation of applying constraints to machine data, in accordance with an aspect of this disclosure.

### DETAILED DESCRIPTION

In conventional systems using conventional methods, it is difficult to embed software on an electronic controller unit (ECU) of a machine quickly for the purpose of on-board data analytics, the term “on-board” referring to the ECU being physically present on or inside the machine. Doing so quickly is hard since developers are less productive in low-level programming languages and releasing the machine with un-tested control-side software runs the risk that the machine could potentially malfunction in the field. Thus, the development and validation cycles for such embedded software are quite long, leading to various delays in the overall project for which the machine is deployed.

Various aspects of this disclosure are related to addressing the problems in the conventional operation of machines generating large amounts of machine data in a raw data format understandable only by an on-board electronic controller module of the machine. Various aspects of this disclosure provide specific details for handling the machine data on a mobile device separate from the machine. Further, there is a need for a new platform for developing and testing (and eventually deploying to the customer) a broad new category of embedded machine analytics. By performing machine data analytics on the mobile device to provide requested data processed in a format understandable by a user, a customer or an operator of the machine may in real-time assess a performance of the machine or a part thereof and take appropriate actions to predict and/or remedy a potential problem that may occur with the machine and/or the part thereof. An exemplary advantage of the aspects of this disclosure is that customizable machine data analytics can be performed on the mobile device, off-board the machine. Specific information can be transmitted to a customer or user thereby reducing the amount of bandwidth used to transmit the information, and hence reducing the cost to the customer who does not have to pay for information that was not required or requested by the customer to begin with.

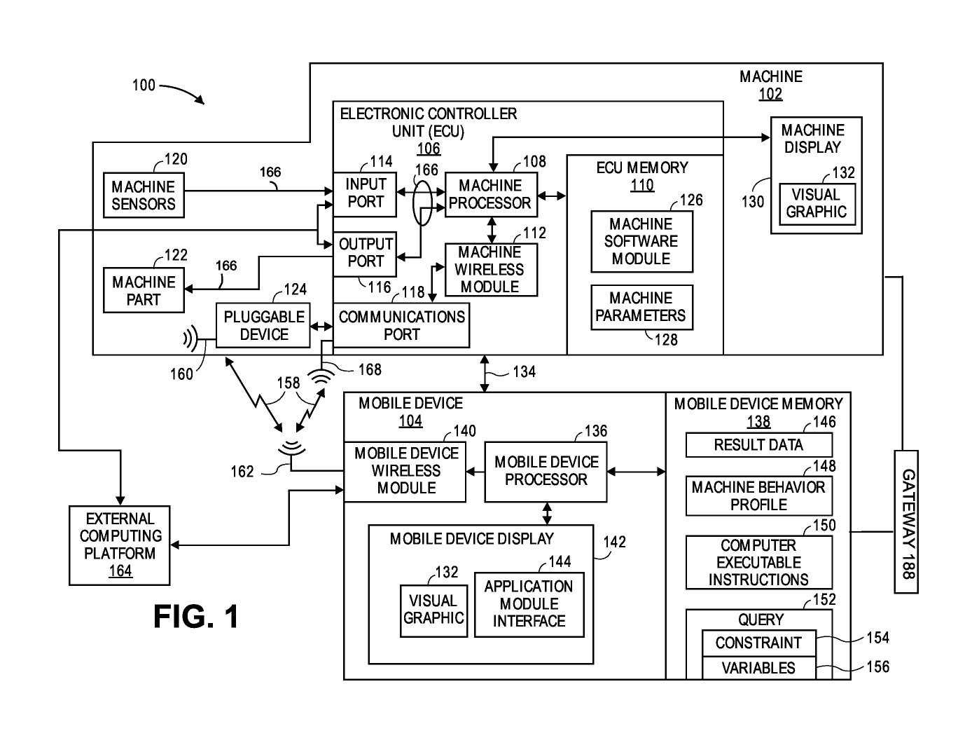

Now referring to the drawings, where like reference numerals refer to like elements, FIG. 1 illustrates a system 100, in accordance with an aspect of this disclosure. The system 100 includes a machine 102 and a mobile device 104. The system 100 may include additional or optional components (not explicitly shown). Such components may include, but are not limited to, an external computing platform 164, a base station with which the machine 102 and/or the mobile device 104 may communicate, a satellite positioning system, a customer or a third party computing infrastructure, additional machines and mobile devices, human and/or robotic operators for the machine 102 and/or the mobile device 104, and the like. The machine 102 and/or the mobile device 104 may be deployed in a worksite that is operated upon by the machine 102 to alter physical characteristics of the worksite.

By way of example only and not by way of limitation, the machine 102 may be an off-highway truck, a motor grader, a track type tractor, a dozer, a scraper, a backhoe loader, a paver, a crane, or other types of machines or vehicles associated with construction, mining, paving, landscaping, and/or agriculture. Further by way of example only and not by way of limitation, the mobile device 104 may be a handheld mobile phone, a “smart” phone, a portable tablet computing device, a laptop computer, and the like, configured to implement various features and functionalities of the various aspects of this disclosure. It will be appreciated that a physical placement of the various devices and components of the machine 102 are for discussion purposes by way of example only and an actual placement of these components and devices on the machine 102 will vary depending upon a physical design, type, or structure of the machine 102, as will be understood by one of ordinary skill in the art in view of this disclosure.

In one aspect of this disclosure, the mobile device 104 is in wireless communication with or is wirelessly connected to the machine 102 and located within a wireless communication range 134 of the machine 102. Such wireless connections may occur over wireless signals 158. For example, the wireless communication range 134 may be defined by a wireless standard established between the machine 102 and the mobile device 104. Such a wireless standard may include, but is not limited to a Bluetooth® standard, a WiFi™ standard, a Universal Synchronous Bus (USB) standard adapted for wireless capabilities, and the like, or combinations thereof. For example, the wireless communication range 134 may vary from 0 m to 100 m for a wireless connection of the mobile device 104 with the machine 102 using the Bluetooth® standard. Likewise, the wireless communication range 134 may vary based on the type of wireless standard used for the wireless connection between the mobile device 104 and the machine 102, as will be appreciated by one of ordinary skill in the art reading this disclosure.

In another aspect of this disclosure, the mobile device 104 may be wirelessly connected to the external computing platform 164. The term “external” as relates to the external computing platform 164 may refer to a computing device or a group of computing devices that are not part of the machine 102 and the mobile device 104. In this respect, the external computing platform 164 may be an external computing device. For example, the external computing platform 164 may be a customer site computing infrastructure, a base station computing infrastructure, another mobile device, and the like. The mobile device 104 may communicate with the external computing platform 164 over long-haul, short-haul, and/or mobile communication infrastructure and/or back-office infrastructure. In yet another aspect, the external computing platform 164 may be optional.

The machine 102 may include an electronic controller unit (ECU) 106, machine sensors 120, a machine part 122 controllable by the ECU 106, and a machine display 130. The machine 102 may include additional components not shown in FIG. 1. Such components may include, but are not restricted to, hydraulic systems, power generation and distribution units, chassis, ground engagement mechanisms (e.g., tires), steering mechanism, cooling systems, combustion engines, rechargeable non-combustion engines, hybrid and/or dual-fuel engines, motors, valves, an operator cab, communication antenna, etc.

The ECU 106 may include a machine processor 108, an ECU memory 110, a machine wireless module 112, an input port 114, an output port 116, a communications port 118 coupled to each other by a controller area network (CAN) bus 166, although other types of data buses may be used, including but not limited to, Caterpillar Data Link (CDL) bus, Modbus, and/or Ethernet data links. In one aspect of this disclosure, the input port 114, the output port 116, and the communications port 118 may be co-located or may be integrated as a single port having separate or shared pins or channels for respective functionalities of the input port 114, the output port 116, and the communications port 118. Additionally or optionally, the ECU 106 may include other components, including but not restricted to, a CAN bus controller chip, a power supply, heat sinks, user-interface, digital signal processors (DSPs), analog-to-digital converters (ADCs), digital-to-analog converters (DACs), analog and digital filters, displays, visual and/or audio indicators (e.g., light emitting diodes, speakers), etc. Although FIG. 1 illustrates only a single ECU (i.e., the ECU 106), the machine 102 may include a plurality of ECUs. The ECU 106 is configured to receive a plurality of inputs from the machine sensors 120 at the input port 114 and to output a plurality of signals from the output port 116 to the machine part 122. Additionally or optionally, the ECU 106 may receive inputs from or provide outputs to the external computing platform 164.

The machine processor 108 may be an ‘n’-bit processor fabricated, for example, using complementary metal-oxide semiconductor (CMOS) fabrication technology (‘n’ being a positive integer). By way of example only, the machine processor 108 may be configured to execute computer code for running a machine software module 126 in the ECU memory 110. In one aspect, the machine processor 108 may be coupled to or may include a programmable logic circuit (PLC), an Application Specific Integrated Circuit (ASIC), a Field Programmable Gate Array (FPGA), a Programmable Logic Array (PLA), a System-on-a-Chip (SOC), or the like (not shown). The machine processor 108 may further include logic circuitry such as Boolean gates (“AND”, “OR”, and “NOT”) to carry out various binary operations based on the wireless signals 158 from the mobile device 104 and/or the machine sensors 120.

In one aspect, the machine processor 108 may be coupled to the ECU memory 110. The ECU memory 110 may be implemented as a non-transitory computer readable medium. By way of example only, the ECU memory 110 may be a semiconductor based memory device including but not limited to random access memory (RAM), read only memory (ROM), Dynamic RAM, Programmable ROM, Electrically Erasable programmable ROM (EEPROM), Static RAM, Flash memory, combinations thereof, or other types of memory devices known to one of ordinary skill in the art. The ECU memory 110 may store the machine software module 126 and machine parameters 128 in different memory regions in the ECU memory 110. The machine software module 126 may include computer code utilized by the machine processor 108 for operation of the machine 102, for example, upon receiving the wireless signals 158 from the mobile device 104.

The machine parameters 128 may be generated based upon inputs from the machine sensors 120 and/or inputs from an operator of the machine 102. By way of example only and not by way of limitation, the machine parameters 128 may include a speed of the machine 102, an output force provided to the machine part 122, a temperature of the machine 102, an electrical parameter associated with the machine 102, a payload value on the machine part 122, etc.

The machine wireless module 112 may include transceivers, filters, and signal amplifiers to communicate with the mobile device 104. In one aspect, the machine wireless module 112 may be coupled to the communications port 118 to transmit and/or receive signals to the mobile device 104 via a machine antenna 168. The machine wireless module 112 may include circuitry to handle and process WiFi™, Bluetooth®, and/or USB signals for wireless communication between the ECU 106 and the mobile device 104.

Alternatively, additionally, or optionally, the machine wireless module 112 may be coupled to a pluggable device 124 at the communications port 118 and may communicate to the mobile device 104 via a pluggable device antenna 160. By way of example only, the pluggable device 124 may be a USB device with communications capabilities. In yet another aspect, the pluggable device 124 may be used when the ECU 106 does not have the machine wireless module 112, in which case the pluggable device 124 acts as a wireless transceiver for wireless communication with the mobile device 104.

Machine sensors 120 may include, but are not limited to, pressure sensors, temperature sensors, current sensors, voltage sensors, accelerometers, inertial measurement units (IMUs), optical sensors, acoustic sensors, grade sensors, level sensors, gyroscopes, and the like. During operation of the machine 102, the machine sensors 120 continuously provide real-time electrical signals to the ECU 106. The electrical signals are then converted to a machine data structure by the machine processor 108. Such machine data structure may be unique to the type of the machine 102 and is referred to as “raw data” or data in a “raw format.” The raw data in the machine data structure is associated with the machine parameters 128 and stored in the ECU memory 110.

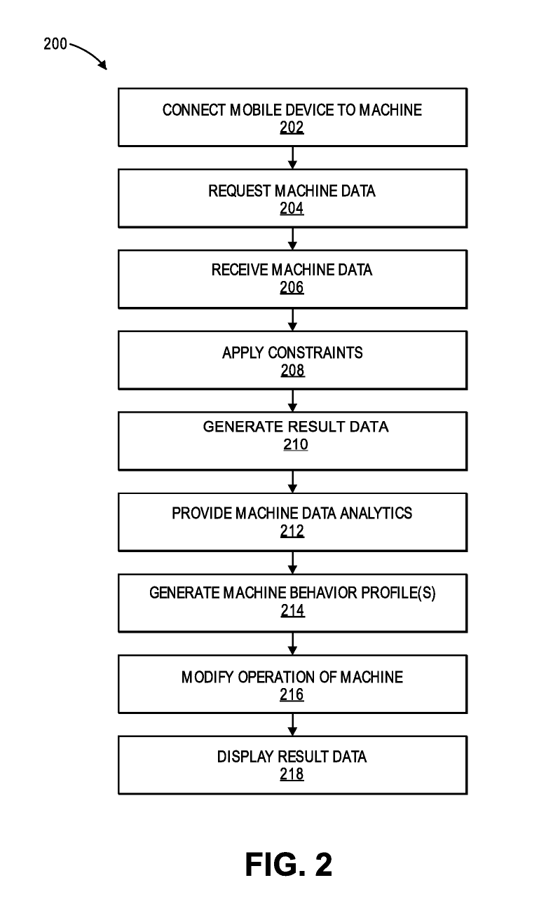

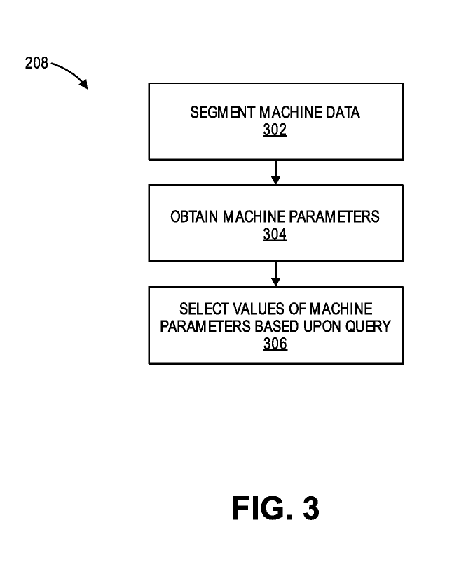

The machine part 122 may include, but is not limited to, an implement, a work tool, a bucket, a compactor, a harvester, or other types of mechanical, electrical and/or electro-mechanical components controllably driven by the ECU 106. For example, the machine part 122 may be coupled to a boom or a lift arm (not shown) of the machine 102 for use in the worksite in which the machine 102 is deployed. A movement of the machine part 122 may be controlled using hydraulic arms (not shown) controlled by actuators (not shown) coupled to and actuated by the ECU 106. Further, as discussed with respect to FIGS. 2-3, an operation of the machine 102 and/or the machine part 122 may be modified by the mobile device 104.

The machine display 130 may be an output device controllable by the machine processor 108. The machine display 130 may be a liquid crystal display (LCD), an Organic Light Emitting Diode (OLED) display, a cathode ray tube type display, a wearable display, or other types of output devices known to one of ordinary skill in the art. In one aspect, the machine display 130 may include a visual graphic 132 indicating one or more of the machine parameters 128. By way of example only and not by way of limitation, the visual graphic 132 may be a static or a dynamic image obtained in real-time operation of the machine 102, a visual representation of one or more of the machine parameters 128, a video of operation of the machine 102, and the like or combinations thereof.

In one aspect of this disclosure, the mobile device 104 may include a mobile device processor 136, a mobile device memory 138, a mobile device wireless module 140, and a mobile device display 142. As used with respect to the mobile device 104, the term “mobile” relates to a portable computing device carried by an operator, a user or a technician associated with the machine 102. As discussed, examples of the mobile device 104 may be a cellular phone, a tablet device, a “phablet” device having telephone and computing capabilities, a smart phone, and the like. Generally, the mobile device 104 can support an application module interface 144 that is used by the user, the operator or the technician at the mobile device 104 to interact with the machine 102 to obtain machine data associated with the machine parameters 128. Additionally or optionally, the mobile device 104 may include other components, including but not restricted to, a power supply (battery), heat sinks, user-interface, digital signal processors (DSPs), analog-to-digital converters (ADCs), digital-to-analog converters (DACs), analog and digital filters, visual and/or audio indicators (e.g., light emitting diodes, speakers), haptic actuators, optical sensors, communication and noise cancellation circuitry, and the like.

The mobile device processor 136 may be an ‘n’-bit processor fabricated, for example, using complementary metal-oxide semiconductor (CMOS) fabrication technology (‘n’ being a positive integer). Such processor may be single core or multiple core type and may include or be collocated with a graphics processor unit (GPU). By way of example only, the mobile device processor 136 may be configured to execute computer executable instructions 150 in the mobile device memory 138. In one aspect, the mobile device processor 136 may be coupled to or may include a programmable logic circuit (PLC), an Application Specific Integrated Circuit (ASIC), a Field Programmable Gate Array (FPGA), a Programmable Logic Array (PLA), a System-on-a-Chip (SOC), or the like (not shown). The mobile device processor 136 may further include logic circuitry such as Boolean gates (“AND”, “OR”, and “NOT”) to carry out various binary operations based on the wireless signals 158 from the machine 102 (e.g., from the ECU 106).

The mobile device memory 138 may be implemented as a non-transitory computer readable medium. By way of example only, the mobile device memory 138 may be a semiconductor based memory device including but not limited to random access memory (RAM), read only memory (ROM), Dynamic RAM, Programmable ROM, Electrically Erasable programmable ROM (EEPROM), Static RAM, Flash memory, combinations thereof, or other types of memory devices known to one of ordinary skill in the art. In one aspect of this disclosure, the mobile device memory 138 may include result data 146, a machine behavior profile 148, the computer executable instructions 150, and a query 152 in distinct physical areas of the mobile device memory. The query 152 may include a constraint 154 and variables 156 associated with the machine parameters 128, as discussed with respect to FIGS. 2-3. Likewise, the result data 146 and the machine behavior profile 148 are further discussed with respect to FIGS. 2-3.

The mobile device display 142 may be an output device controllable by the mobile device processor 136. The mobile device display 142 may be a liquid crystal display (LCD), an Organic Light Emitting Diode (OLED) display, or other types of output devices known to one of ordinary skill in the art. In one aspect, the mobile device display 142 may include the visual graphic 132 indicating one or more of the machine parameters 128 and the application module interface 144. By way of example only and not by way of limitation, the visual graphic 132 may be a static or a dynamic image obtained in real-time operation of the machine 102, a visual representation of one or more of the machine parameters 128, a video of operation of the machine 102, and the like or combinations thereof. The application module interface 144 may be a graphical user interface (GUI) configured to accept inputs from a user of the mobile device 104 and present the result data 146. It will be appreciated by one of ordinary skill in the art reading this disclosure that the mobile device display 142 may include additional graphic icons presenting different types of information related and unrelated to the machine 102. Further, audio, text, or other formats of presenting the result data 146 may be used in addition to or as an alternative to the visual graphic 132.

The mobile device wireless module 140 may include transceivers, filters, and signal amplifiers to communicate with the machine 102. In one aspect, the mobile device wireless module 140 may be coupled to a mobile device antenna 162 to transmit signals to and/or receive signals from the ECU 106 and/or the pluggable device antenna 160. The mobile device wireless module 140 may include circuitry to handle and process WiFi™, Bluetooth®, and/or USB signals in the wireless signals 158 for wireless communication between the ECU 106 and the mobile device 104.

### INDUSTRIAL APPLICABILITY

This patent disclosure relates generally to e data analytics for machines, and more particularly, to a system and a method for performing data analytics for a machine on a mobile device.

Conventional systems and methods for machines include on-board processing of machine data by an electronic controller module (ECM) or electronic controller unit (ECU) inside or on-board the machine. The ECM/ECU processes large amounts of machine data in a raw or native machine data structure that take up a large amount of communication bandwidth when transmitted to off-board devices remote from the machine. Some conventional systems, monitor parameters associated with the machine and may provide selective vehicle information to a terminal on the machine. Such a terminal is on-board and may then transmit vehicle data to a provider center or third party through a mobile computing platform on the vehicle itself over a mobile communications system infrastructure.

Some conventional systems use a portable apparatus for processing machine data. The portable apparatus is not integral to the machine. However, the portable apparatus is used for a specific application of real-time operation-based operator coaching system, based upon the machine data processed at the portable device.

Therefore, as disclosed in this patent application, what is needed is a mobile computing platform that can be flexibly programmed to process machine data for specific applications as requested by a user or customer using the machine in a format understandable by the user or the customer of the machine. Various aspects of this disclosure are used to monitor values of the machine parameters 128, provide feedback to the operator, issue alerts, acquire data on the field distribution of one or more parameters in the machine parameters 128, troubleshoot, develop new mobile/embedded algorithms, field test new operator applications/services, and assist in jobsite optimization of various processes of which the machine 102 is part of. Generally, various aspects of this disclosure may be used to manage the information flow and to perform analytical processing of data for insights into behavior of the machine 102 during operation.

Referring to FIG. 2, there is illustrated a method 200 for operating the machine 102 based on machine data analytics performed on the mobile device 104, in accordance with an aspect of this disclosure. The machine data analytics performed on the mobile device 104 may include performing one or more of operations discussed with respect to FIGS. 2-3 using, e.g., by mobile device processor 136. FIGS. 2-3 present the method 200 as a flow diagram, although the method 200 may be understood using other types of presentations such as process diagrams, graphs, charts, equations, data visualizations, data animations, and videos presented on the mobile device display 142, etc. In one aspect, one or more processes or operations in the method 200 may be carried out by the mobile device processor 136, using various inputs and/or signals generally from the machine 102, and particularly from the ECU 106, by executing the computer executable instructions 150 stored in the mobile device memory 138.

In another aspect, in the method 200, one or more processes or operations, or sub-processes thereof, may be skipped or combined as a single process or operation, and a flow of processes or operations in the method 200 may be in any order not limited by the specific order illustrated in FIGS. 2-3. For example, one or more processes or operations may be moved around in terms of their respective orders, or may be carried out in parallel. The term “flow,” as used with respect to FIGS. 2-3, generally refers to a logical progression of operations in an exemplary manner carried out by the mobile device processor 136. However, such a flow is by way of example only and not by way of limitation, as at a time, the flow may proceed along multiple operations or processes of the method 200. Further, the method 200 may be carried out by the mobile device processor 136 for various sizes and various types of machines and ECUs and is not limited to the machine 102 and/or the ECU 106. The method 200 may be implemented by the mobile device processor 136 in a low-level (Assembly, C, C++, FORTRAN, etc.) or high-level (Python, Julia, MATLAB, LuaJIT, Javascript, Go, etc.) programming language using logic circuitry and by executing the computer executable instructions 150 in the mobile device memory 138.

The method 200 may begin in an operation 202 in which the mobile device processor 136 wirelessly connects to the ECU 106. In one aspect, the mobile device 104 automatically connects to the ECU 106 when the mobile device 104 is within the wireless communication range 134. Such automatic connection of the mobile device 104 may be based upon prior connection knowledge between the ECU 106 and the mobile device 104. For example, the mobile device antenna 162 may broadcast a connection request to the machine antenna 168, and/or when present, to the pluggable device antenna 160. The machine processor 108 may authenticate the mobile device 104 as a valid device based upon validation and authentication information transmitted by the mobile device antenna 162 over the wireless signals 158. Such validation and authentication of the mobile device 104 is known to one of ordinary skill in the art, and will not be described in detail herein.

In another aspect, the mobile device 104 does not directly connect to the ECU 106. Instead, the mobile device 104 is connected to the machine 102 through a gateway 188. The gateway 188 includes a publisher software application that runs on the machine 102 (e.g., on a network manager of the ECU 106). The publisher software application reads messages from various data links of the machine 102 (e.g., the CDL, J1939, CAN, Ethernet, etc.) and publishes them to the mobile device 104 through a Web-based Application Program Interface (API). Thus, in this aspect, the mobile device 104 does not have unrestricted access to the ECU 106. The gateway 188 provides a secure, reliable connection to the machine 102 that can filter communications and restrict activity so that the control of the machine 102 and the information related to the machine 102 operation cannot be exploited. Further, in this aspect, the web-based API authenticates the mobile device 104, instead of the machine 102.

In an alternative aspect of this disclosure, the mobile device processor 136 of the mobile device 104 may wirelessly connect to the ECU 106 when the mobile device 104 receives the query 152 in the mobile device memory 138 or has the query 152 pending. In this respect, when the mobile device 104 does not have the query 152 pending, the mobile device 104 may not connect to the ECU 106 even though the mobile device 104 may be within the wireless communication range 134. Such conditional connection of the mobile device 104 may optimize bandwidth of communication for the ECU 106 to communicate with other devices that may be within the wireless communication range 134 but have requests for machine data associated with the machine parameters 128 pending.

In yet another alternative aspect, the mobile device processor 136 may wirelessly connect to the machine 102 based upon a request from the machine 102 to send machine data associated with the machine parameters 128. In this aspect, the machine 102 may search for valid mobile devices and may determine that the mobile device 104 can process the machine data and perform machine data analytics. Accordingly, the mobile device processor 136 may detect a request for wireless connection over the wireless signals 158 from the ECU 106 and may then wirelessly connect to the ECU 106 of the machine 102. Further, the mobile device 104 may connect to a plurality of machines and the wireless connection of the mobile device 104 to the machine 102 is by way of example only and not by way of limitation. For example, when connected to more than one machines, the mobile device processor 136 may deploy time division, frequency division, code-division multiple-access techniques, and the like, or combinations thereof to manage connections with such a plurality of machines.

In another aspect of this disclosure, the arrangement of components or the architecture illustrated in FIG. 1 is a “pub-sub” design where the on-board publisher software application of the ECU 106 is always ready to send information, and when the mobile device 104 (or other mobile devices) has authenticated and subscribes to the WebSocket of the ECU 106, the data begins to flow from the machine 102 to the mobile device 104. The network manager of the ECU 106 does not request transfer, instead the mobile device 104 subscribes and receives the data associated with the machine parameters 128.

In still another aspect of the disclosure, the connection of the mobile device 104 to the machine 102 may occur when the machine 102, or specifically the ECU 106, is upgraded to have wireless communication capabilities (e.g., the ECU 106 is upgraded to have a WiFi™ capability). In this scenario, the machine 102 may previously, prior to the upgrade, have required a wired connection to the mobile device 104 to communicate with the mobile device 104, or may have relied upon the pluggable device 124 for wireless communication with the mobile device 104. However, when the ECU 106 is upgraded from having non-wireless circuits to wireless circuits, e.g., of the machine wireless module 112, the mobile device 104 may detect such an upgrade and may request connection with the machine 102.

In an operation 204, the mobile device processor 136 may request machine data associated with the machine parameters 128 from the ECU 106. The mobile device processor 136 may request the machine data based upon the query 152 received from an operator of the mobile device 104 or from the external computing platform 164 or both. Such a request from the mobile device processor 136 to the ECU 106 may relate to a physical parameter, a mechanical parameter, a chemical parameter, or combinations thereof in the machine parameters 128 associated with the machine 102 and/or the machine part 122. For example, the request from the mobile device processor 136 may include information pertaining to the machine parameters 128 such as how the machine part 122 is positioned, whether the machine 102 is being operated properly, how the machine 102 operated during a given time period, at what speed, etc. In another example, the request may include information pertinent to one or more customers or users of the machine 102.

In another example, one customer may be interested in how fast the machine 102 can complete a job on the worksite that the machine 102 is deployed on, while another customer may be interested in whether the engine of the machine 102 is overheating or is not at an optimal temperature. In yet another example, the customer using the machine 102 may be interested in obtaining data related to the machine sensors 120 (e.g., tire pressure, oil pressure, etc.) and the mobile device 104 may forward such requests using the application module interface 144 communicating with the mobile device processor 136 and the mobile device memory 138.

The request(s) for such machine data from the mobile device 104 may be based upon a data plan that a customer of the machine 102 may have agreed to. For example, as part of the data plan, the customer may request only certain types of data from the machine 102 and not all of the raw data that the machine 102 generates. The mobile device 104 may include only the data requested by the customer as part of the request to the machine 102 for the machine data. Such specific requests for data by the customer may be included in the query 152. The mobile device 104 may request the data for one such customer or a plurality of customers. The request may be sent to the machine 102 using the application module interface 144 displayed on the mobile device display 142.

In an operation 206, the mobile device 104 may receive machine data associated with the machine parameters 128 from the ECU 106. The mobile device 104 may receive the machine data over the wireless signals 158 at the mobile device wireless module 140. In one aspect, the machine data may be in a machine data structure upon arrival at the mobile device 104. Such machine data structure may, by itself in its raw data format, not be intelligible to a user or customer of the machine 102. For example, the raw machine data structure may be in binary, arranged as a plurality of binary data packets, which by themselves may be unreadable by a customer.

Such machine data received at the mobile device 104 may be a pre-specified time series channel data including but not limited to the machine parameters 128 for lever commands for the machine 102, engine speed or transmission speed, hydraulic pressures in a hydraulic component of the machine 102, accelerometer signals from the machine sensors 120, a payload value of the machine part 122, a distance travelled by the machine 102, Global Positioning System (GPS) data for the machine 102, data in video encoded format, or other types of time series data obtained for real-time operation of the machine 102 in a machine data structure. The machine processor 108 may obtain such machine data from the CAN bus 166 and/or the ECU memory 110 and transmit the machine data from the communications port 118 to the mobile device antenna 162 over the wireless signals 158. As discussed, the mobile device 104 may receive such data as a WiFi™ signal, a Bluetooth® signal, or the like.

In one aspect, the ECU 106 may not have wireless transmission capabilities. In such a scenario, the mobile device 104 may receive the machine data upon transmission from the pluggable device antenna 160 of the pluggable device 124. For example, the pluggable device 124 configured as an adapter to convert data at the communications port 118 in CAN bus format of the CAN bus 166 to one or more of the wireless signals 158.

In an operation 208, the mobile device processor 136 may apply the constraint 154 to the received machine data associated with the machine parameters 128. In one aspect, the constraint 154 may be applied based upon receiving an input from a user of the mobile device 104, e.g., from the application module interface 144. In another aspect, a plurality of constraints (including the constraint 154) may be applied to the received machine data. The constraint 154 may be applied as a data filter to the received machine data based upon the variables 156 in the query 152. The variables 156 may depend upon specific information requested by the user or the customer of the machine 102.

The application of the constraint 154 in the operation 208 to the received machine data may further include operations 302-306 illustrated in FIG. 3, in accordance with an aspect of this disclosure. The operation 208 may begin in the operation 302 in which segmenting of the machine data into time periods of operation of the machine 102 is carried out by the mobile device processor 136. The term “segmenting,” as used herein, may relate to splitting the time-series channel data received in the operation 206 into distinct periods of operation of the machine 102. Alternatively, the mobile device processor 136 may perform the segmenting based upon other criteria defined in the query 152. For example, segmenting of the received machine data may be carried out based upon machine data for different modes of operation of the machine 102 and/or the machine part 122, different types of the machine sensors 120, and for different applications (loading, dumping, scraping, etc.) for which the machine 102 and/or the machine part 122 was used. The segmenting may be carried out by an analytic module implemented by executing the computer readable instructions 150 on the mobile device 104 to segment the machine data into time periods of distinct operation of the machine 102, and then calculate performance or severity characteristics for each of these segments of machine data. These time period segments with associated statistical measures are then forwarded (e.g., through a cellular network, WiFi™, the Internet, etc.) to a central data management location (not shown) where they are pooled across machines to arrive at a large-sample distribution. The large sample distribution may then be presented back to the mobile device 104 (as well as other individual mobile devices) to show the operator how the operator is performing (e.g., in the 50th, the 90th percentile, etc.).

Further, the segmenting may be carried out depending upon what an end goal for obtaining the machine data at the mobile device processor 136 may be. For example, the segmenting may be used to generate profiles of real-world customer usage data (as opposed to a test scenario data) to better obtain a design optimization of the machine part 122, to detect potential downtimes of the machine 102, to automate the worksite in which the machine 102 is deployed using on-board machine data for machine analytics on the mobile device 104 (as opposed to performing machine data analytics in a customer back-office site), to provide service and customer support, and/or to perform coaching of an operator of the machine 102, and like, or combinations thereof.

In an operation 304, the mobile device processor 136 may obtain the machine parameters 128 during the segmented time periods. For example, the mobile device processor 136 may receive machine data for past 24 hours of operation, although any other time period may be used. However, the mobile device processor 136 may know from the variables 156 in the query 152 that at a time, the machine data for an eight-hour shift of an operator of the machine 102 is being requested by the customer renting or deploying the machine. Accordingly, the mobile device processor 136 may segment the machine data received for the 24 hour period into three data blocks each with a duration of eight hours.

In an operation 306, the mobile device processor 136 carries out selecting the values of the machine parameters 128 from the segmented machine data based upon one or more of the variables 156 indicated in the query 152 received by the mobile device processor 136. For example, the variables 156 may pertain to a specific type of the machine sensors 120 that measure the machine parameters 128 for the machine part 122 during a specific mode of operation of the machine 102. The mobile device processor 136 may apply the constraint 154 associated with the variables 156 according to the specific type of the machine sensors 120 and the specific mode of operation to select specific numerical values from the segmented machine data. Further, such selection of the values of the machine parameters 128 may be based upon the data requested by the customer, as discussed, with respect to an amount that the customer pays for the data or the bandwidth used in transmitting such data to the customer.

Referring back to FIG. 2, after applying the constraint 154, in an operation 210 the mobile device processor 136 may carry out generating the result data 146 in a mobile device data structure based upon the constraint 154 applied to the machine data. The mobile device data structure may have a format compatible with the mobile device 104. The result data 146 is extracted specific to the query 152 and may vary between queries. The result data 146 may include, but is not restricted to, performance or severity characteristics for each segment of the machine data, a rate of change of one or more of the machine parameters 128, a boundary value or an exception value of one or more of the machine parameters 128, a site productivity report for the worksite in which the machine 102 is deployed, environmental factors associated with the machine 102 (e.g., gradient of terrain, smoothness, etc.), a video stream corresponding to the operation of machine 102 during the segmented time periods, fuel efficiency for an engine of the machine 102, durability of the machine 102 under different operating conditions, and the like.

To convert the raw machine data to generate the result data 146 in a presentable format for the user of the mobile device 104 and/or the customer of the machine 102, the mobile device processor 136 may execute the computer executable instructions 150 to implement the analytic module or analytic algorithm to convert the binary raw data format and/or CAN bus data format to a format easily readable by the user of the mobile device 104 and/or the customer.

In one aspect of this disclosure, the result data 146 may be presented on the mobile device display 142 and/or the machine display 130. The result data 146 may be presented for the machine parameters 128 by the mobile device processor 136 by converting the selected values of the machine parameters 128 per the query 152. For example, the selected values of the machine parameters 128 may be based upon one or more of the variables 156 indicated in the query 152 received by the mobile device processor 136.

In an operation 212, the mobile device processor 136 may perform data analytics on the result data 146 and/or the machine data associated with the machine parameters 128 received in the operation 206. Such data analytics may include performing descriptive, predictive, and/or prescriptive data analytics. Descriptive data analytics may provide an explanation or a summary of the result data 146 in a manner easily understandable to a customer or a user of the machine 102. Predictive data analytics may be used to predict a future course of operation of the machine 102. Predictive data analytics also can be applied on given data to predict an unknown quantity not known at the time, whether it be past, present, or future. A predictive model may tell you what type of operation the machine was doing based on the raw data even though this information is not directly specified in the machine parameters. Prescriptive data analytics may provide suggestions for improving or enhancing the operation of the machine 102 and/or the machine part 122 to the user or the customer and to improve an overall logistics process in which the machine 102 may be taking part.

The mobile device processor 136 may calculate predictive values of the machine parameters 128. The predictive values may be calculated by applying pattern detection to the machine data received in the operation 206 or to the result data 146. For example, the mobile device processor 136 may perform condition-based monitoring for various parts of the machine 102 to determine predictive values of the machine parameters 128. Such condition-based monitoring may include using a pattern detection analytic algorithm (implemented by executing the computer readable instructions 150) to determine if the machine 102 has entered a potential condition for failure. The mobile device processor 136 may look for a rate-of-change condition for the machine parameters 128, a boundary exception, or a predicted condition based on machine learning classification implemented using the computer executable instructions 150. Whenever the mobile device processor 136 detects a potential for failure, additional logic can be run based on whether the mobile device processor 136 should alert a back-office, notify the operator, or in rare cases, de-rate the machine 102.

The pattern detection may be used in a customer service and support scenario to provide machine data analytics to the customer. For example, the customer may record a live video of the operation of the machine 102. When the user pauses or stops the recording of the live operation of the machine 102 as a video, this video data is annotated properly to synchronize the data and video and packaged into a single file. The file can then be uploaded to a dealer or a back office for review. Alternatively, the data and the video can be analyzed on the mobile device 104 by applying the pattern-detection scheme to see if the data and the video match a problem seen before. If so, the analytic module could offer prescriptive analytics or contact/alert the dealer to diagnose a problem that may arise in the future with the machine 102, without physically visiting the worksite in which the machine 102 is deployed.

The mobile device processor 136 may provide such predictive values by aggregating the result data 146 for a period of time. The period of time may be dependent on the constraint 154 provided by the query 152 and/or the specific types of the machine parameters 128 that are requested and analyzed at the mobile device 104. For example, when an automation of the worksite in which the machine 102 is deployed is to be carried out using the machine data, the aggregating may be carried out by the analytic module running the analytic algorithm to aggregate the site productivity information, along with site preparation/production plans and environmental factors, and make decisions on where the machine 102 should be guided, at what speed, and through what path, etc. This would help an autonomous fleet of machines (including the machine 102) to be more productive and efficient as a fleet and not just as individual machines.

The predictive values may provide information regarding a future value of one or more of the machine parameters 128 to a user of the mobile device 104. For example, the mobile device processor 136 may determine that the machine parameters 128 indicate machine data for swivel angles of a bucket attached to the machine 102. The mobile device processor 136 may apply pattern detection to detect instances during the operation of the bucket when the swivel angles exceeded recommended values for the swivel angles. Further, the mobile device processor 136 may predict future values for the swivel angles for the bucket if the bucket continues to operate based on the current swivel angle values received from the machine processor 108.

Such future values may be used to generate simulation models for performance of the machine 102 and or the machine part 122 under different circumstances. The simulation models may aid a designer of the machine 102 to avoid an over-design or an under-design of the machine 102 and/or the machine part 122 based upon the predictive values of the machine parameters 128. Such predictive values may aid in selecting specific algorithms in the machine software module 126 executed by the machine processor 108 that control the operation of the machine 102 and/or the machine part 122. For example, such algorithms may be turned on/off based upon the predictive values, or generally, based upon the machine analytics carried out using the mobile device processor 136. Algorithms may be activated or deactivated, for example, based upon setting of flags in the ECU memory 110. Other examples of utilizing such predictive values include, but are not limited to, installing or removing algorithms in the ECU memory 110 using the mobile device processor 136, predicting condition of the machine sensors 120 using the mobile device processor 136, setting metadata fields in the ECU memory 110 using the mobile device processor 136, reducing dimensions of the received machine data in the operation 206, determining a quality of the machine data received and whether the quality is acceptable for transmission to a customer or the external computing platform 164, and the like, or combinations thereof.

Likewise, the mobile device processor 136 may prescribe recommendations for improving or enhancing the operation of the machine 102 and/or the machine part 122 based upon the result data 146. For example, the mobile device processor 136 may indicate to the user of the mobile device 104 an optimum speed, temperature, acceleration, etc. that the machine 102 and/or machine part 122 should operate with to maximize fuel efficiency. Generally, the mobile device processor 136 may carry out such prescriptive data analytics on any of the machine parameters 128 in a multi-variable analysis for the variables 156 of the query 152. Likewise, the constraint 154 may be applied to the result data 146 to obtain information regarding optimized operation of the machine 102 and/or the machine part 122.

In an operation 214, the mobile device processor 136 may generate the machine behavior profile 148. The machine behavior profile 148 may be in the form of a table, the visual graphic 132, and/or a video, for example, to indicate an expected behavior of the machine 102 and/or the machine part 122 under the constraint 154. In one aspect, the machine behavior profile 148 may be generated using the pattern detection applied to the result data 146 in the operation 212. In another aspect, the machine behavior profile 148 may be generated using aggregation of the result data 146 in the operation 212. In yet another aspect, the machine behavior profile 148 may be generated by the mobile device processor 136 using both the pattern detection and the aggregation techniques for the result data 146. The machine behavior profile 148 may include one or more parameters indicating how the machine 102 will operate under the constraint 154. Likewise, a plurality of machine behavior profiles may be generated for a plurality of constraints. By way of example only and not by limitation, the machine behavior profile 148 may identify a type of the machine 102 (paver, dozer, etc.), an engine type (dual fuel, electric, etc.), types and parameters for the machine sensors 120 of the machine 102, a type of the machine part 122 (bucket, compactor, harvester attachment, etc.), structural and operational parameters of the machine part 122 (swivel angle, output force, etc.), communication capabilities of the ECU 106, and the like.

In one aspect, the machine behavior profile 148 may be customizable by a user of the mobile device 104. For example, the mobile device processor 136 may receive as few or as many of the variables 156 for which the machine behavior profile 148 may be generated, for example, using the application module interface 144 to provide a selection of the variables 156 to the mobile device processor 136. The mobile device processor 136 may accordingly generate the machine behavior profile 148 for only the variables 156 that were received in the selection, and not for all of the variables 156 that were used to generate the result data 146 originally as part of the query 152.

In an operation 216, the operation of the machine 102 may be modified based upon the machine data analytics performed by the mobile device 104. In one aspect, the operation of the machine 102 may be modified based upon the result data 146 communicated back to the ECU 106 over the wireless signals 158. The ECU 106 may then modify output signals from the output port 116 to the machine part 122 to control the machine part 122. For example, the machine data analytics performed by the mobile device processor 136 and communicated to the ECU 106 may indicate that the machine part 122 has been moving faster than required or recommended for a specific application in which the machine 102 is being deployed. The ECU 106 may, upon receipt of such machine data analytics, may control an output of a hydraulic system to reduce input power to the machine part 122, which will then move slower or at the recommended speed.

In an alternative aspect, the mobile device 104 may control the operation of the machine 102 based upon the machine data analytics performed by the mobile device processor 136. For example, the machine 102 may be overheating and the machine data analytics indicate that further operation of the machine 102 may result in damage to the machine sensors 120 due to overheating. The mobile device 104 may transmit a control signal over the wireless signals 158 to shut down the machine 102 to prevent damage to the machine sensors 120. The mobile device 104 may send control signals over the wireless signals 158 to the ECU 106 modify the operation of the machine 102 and/or the machine part 122. In yet another aspect, the machine data analytics performed by the mobile device processor 136 may be used by both the ECU 106 and the mobile device 104 to modify operation of the machine 102.

The modification of the operation of the machine 102 and/or the machine part 122 may include, by way of example only and not by way of limitation, remotely configuring at least one machine parameter in the machine parameters 128, installing an update to the machine software module 126 of the ECU 106, controlling an input or an output of the ECU 106 to control the operation of the machine 102 or the machine part 122, monitoring condition of the machine part 122, and/or outputting the result data 146 to an operator of the machine 102.

In an operation 218, the result data 146 may be displayed on the mobile device display 142, the machine display 130, or both, based upon control signals from the mobile device 104 to the ECU 106. The result data 146 may be displayed as part of the visual graphic 132 or independently. In one aspect, the result data 146 may be displayed on a display (not shown) of the external computing platform 164. Further, the visual graphic 132 may be used to perform the modification(s) for the operation of the machine 102 and/or the machine part 122. For example, the visual graphic 132 may be a temperature map of the machine part 122 indicating an overheating of the machine part 122. A user of the mobile device 104 may see the visual graphic 132 indicating the overheating and may turn off the engine of the machine 102, and therefore stop an operation of the machine part 122 preventing further heating. Likewise, the visual graphic 132 may be displayed as a video that upon viewing by the user of the mobile device 104 indicates that the machine part 122 is swiveling beyond a range of angles required for optimal operation of the machine 102. The mobile device processor 136 may be used by the used of the mobile device 104 to send a signal to the operator of the machine 102 to control an angle of swivel for the machine part 122 to fall within a recommended range.

Mobile connected devices (smart phones, tablets, laptops) are ubiquitous, can connect to machines via cheap hardware adapters, have ample storage and processing power, and have Bluetooth®, cellular, and WiFi™ connectivity. Machine data is internally communicated via a controller area network (CAN) bus. Various aspects of this disclosure provide a new platform for developing machine analytics that includes a way to transmit the CAN bus data off-board the machine 102 to a nearby mobile device, e.g., the mobile device 104, using Bluetooth®, WiFi™ USB, or other protocol. Certain commercially available devices known to one of ordinary skill in the art may be modified to provide wireless capability to the ECU 106, e.g., the pluggable device 124 that can be plugged to the communications port 118 of the ECU 106 or directly to the CAN bus.

Further, a data access software module interfacing with the application module interface 144 running on the mobile device 104 transfers the wirelessly-received data from the pluggable device 124 into the analytic module, which utilizes the mobile device memory 138, storage, processing power, and binary code in the form of the computer executable instructions 150 to perform the data analytic in question (either low-level (Assembly, C, C++, FORTRAN, etc.) or high-level (Python, Julia, MATLAB, LuaJIT, Javascript, Go, etc.) programming language). Such processing may include signal processing, descriptive statistics, logic, model predictions, dimensionality reduction, condition monitoring, etc. The mobile device memory 138 may store the result dataset on the mobile device 104 or transmit it off the mobile device 104 to an external location.

Furthermore, a machine-to-machine communications module for performing remote configuration is provided in the mobile device wireless module 140 for remotely installing or removing analytic software, turning algorithms on/off, setting metadata fields, changing the structure of the recorded data over time, configuring analytic parameters or conditions, and determining where the output record sets should be transmitted.

Therefore, various aspects of this disclosure advantageously provide developing, testing, and deployment of a mobile platform supported by the mobile device 104 to optimize operation of the machine 102 and/or the machine part 122.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method for operating a machine using a mobile device, comprising:
connecting wirelessly, by a mobile device processor, a mobile device to an electronic controller unit of a machine;
receiving, at the mobile device processor, machine data for machine parameters associated with the machine from the electronic controller unit, the machine data being in a machine data structure;
applying, at the mobile device processor, a constraint to the machine data in response to a query received at the mobile device processor;
generating, at the mobile device processor, result data in a mobile device data structure based upon the constraint applied to the machine data; and
modifying, by the mobile device processor, an operation of the machine based upon the result data.

2. The method of claim 1, further comprising:
providing, by the mobile device processor, predictive values of the machine data based upon the result data obtained from the generating the result data; and
generating, by the mobile device processor, a machine behavior profile based upon the predictive values, the machine behavior profile indicating an output of the machine subject to the constraint,
wherein the modifying is carried out based upon the machine behavior profile.

3. The method of claim 2, wherein the providing the predictive values includes:
detecting a pattern in the result data for generating the machine behavior profile; and
aggregating the result data for a period of time to obtain the predictive values of the machine data for the generating.

4. The method of claim 1, wherein the connecting is carried out when the mobile device is within a wireless communication range of the machine.

5. The method of claim 1, wherein the connecting is carried out based upon the query received at the mobile device processor from a user of the mobile device or from an external computing device in communication with the mobile device.

6. The method of claim 1, wherein the receiving the machine data includes receiving controller area network (CAN) bus data in a CAN bus data format at the mobile device processor.

7. The method of claim 6, wherein the receiving is carried out based upon a transmission of the machine data on the CAN bus by a pluggable device plugged to a communications port of the electronic controller unit of the machine.

8. The method of claim 1, wherein the applying the constraint includes:
segmenting the machine data into time periods of operation of the machine,
obtaining values of the machine parameters during the time periods, and
selecting the values of the machine parameters based upon one or more variables indicated in the query received by the mobile device processor,
wherein the generating the result data includes converting the values of the machine parameters in the selecting to the mobile device data structure.

9. The method of claim 8, wherein the values of the machine parameters are provided as a visual graphic on a mobile device display or transmitted for displaying as the visual graphic on an external display, said visual graphic being used to perform said modifying.

10. The method of claim 1, wherein the modifying includes at least one of:
remotely configuring at least one machine parameter,
installing an update to a machine software module of the electronic controller unit,
controlling an input or an output of the electronic controller unit to control the operation of the machine or a machine part,
monitoring condition of the machine part, and
outputting the result data to an operator of the machine.

11. A system, comprising:
a machine including an electronic controller unit; and
a mobile device wirelessly connected to the electronic controller unit, the mobile device including a mobile device processor configured to:
communicate wirelessly with the electronic controller unit to receive machine data for machine parameters associated with the machine from the electronic controller unit, the machine data being in a machine data structure,
apply a constraint to the machine data in response to a query received at the mobile device processor,
generate result data in a mobile device format based upon the constraint applied to the machine data; and
modify an operation of the machine based upon the result data.

12. The system of claim 11, wherein the mobile device is a handheld mobile phone.

13. The system of claim 11, wherein the mobile device is connected to the electronic controller unit by at least one of a Bluetooth® or a WiFi™ communication channel.

14. The system of claim 11, wherein the mobile device processor is further configured to:
providing predictive values of the machine data based upon the result data obtained from the generated result data; and
generate a machine behavior profile based upon the predictive values, the machine behavior profile indicating an output of the machine subject to the constraint,
wherein the mobile device processor is configured to modify the operation of the machine based upon the machine behavior profile.

15. The system of claim 11, wherein the machine includes a controller area network (CAN) bus, and the mobile device processor is further configured to receive the machine data in a CAN bus format.

16. The system of claim 11, wherein the machine includes a pluggable device plugged to a communications port of the electronic controller unit of the machine, the mobile device processor further configured to wirelessly receive the machine data transmitted by the pluggable device.

17. The system of claim 11, wherein the mobile device processor is configured to apply the constraint on the machine data by:
segmenting the machine data into time periods of operation of the machine,
obtaining values of the machine parameters during the time periods, and
selecting the values of the machine parameters based upon one or more variables indicated in the query received by the mobile device processor,
wherein the mobile device processor is configured to generate the result data by converting the values of the machine parameters in the selecting to the mobile device data structure.

18. The system of claim 17, wherein the values of the machine parameters are provided as a visual graphic on a mobile device display or transmitted by the mobile device processor for displaying as the visual graphic on an external display, said visual graphic being used by the mobile device processor to modify the operation of the machine.

19. The system of claim 11, wherein the mobile device processor is configured to modify the operation by at least one of:
a remote configuration of at least one machine parameter,
an installation of an update to a machine software module of the electronic controller unit,
a control of an input or an output of the electronic controller unit,
a condition monitoring of the machine part, and
an output of the result data to an operator of the machine.

20. A non-transitory computer readable medium comprising computer executable instructions for operating a machine using a mobile device wirelessly connected to an electronic controller unit of the machine, the computer executable instructions when executed by a mobile device processor cause the mobile device processor to:
communicate wirelessly with the electronic controller unit to receive machine data for machine parameters associated with the machine from the electronic controller unit, the machine data being in a machine data structure,
apply a constraint to the machine data in response to a query received at the mobile device processor,
generate result data in a mobile device format based upon the constraint applied to the machine data, and
modify an operation of the machine based upon the result data.
